(19) United States
(12) Patent Application Publication
(10) Pub. No.: US 2005/0039694 A1
(43) Pub. Date: Feb. 24, 2005

(54) Attachment for releasable pet door flap

(75) Inventor: Ryan E. Johnson, Dawsonville, GA (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 10/643,814

(22) Filed: Aug. 19, 2003

(51) Int. Cl. A01K 1/02

(52) U.S. Cl. 119/501

(57) ABSTRACT

Described is a pet door for providing ingress or egress, for a pet, through a structural member, such as a wall or door. The pet door also offers a weather-resisting feature that prevents the integration of the exterior environment and the interior environment. Because the weather-resisting feature includes a flap that presents potential to entangle a pet, the pet door provides a snap fastener oriented release mechanism for the potentially injurious flap.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention

This invention pertains to a device for allowing a pet to pass through a structural member, such as a door or a wall, while preventing environmental elements from passing through the device when the device is not in use. More particularly, this invention pertains to a device for allowing a pet ingress or egress through a structural member and for protecting the pet from detrimental entanglement with a weather-resisting door flap employed by the device.

2. Description of the Related Art

A pet door allows a pet to independently enter and exit a structure. However, the use of a pet door introduces the concern of exterior environmental elements, such as rain or wind blown particles, entering the structure through the pet door or the interior environmental elements, such as conditioned air, escaping through the pet door. This concern has prompted the design of various weather-resisting features for pet doors.

One weather-resisting feature involves the use of a two flap system to ensure a weather-tight seal between the flap and the frame. The first flap is generally a full flap that substantially fills the opening of the pet door, such as may be found on any pet door. This flap typically includes a small amount of clearance to allow the flap to swing freely within the opening. To account for this clearance and improve the weather-resistance of the pet door, a second flap is employed. The second flap does not cover the pet door opening. Instead, it is shaped so as to follow and overlap the general contour of the opening. The center portion is open to permit passage through the second flap. By engaging both the first flap and the pet door frame, the second flap effectively produces a weather-tight seal on the pet door. Unfortunately, it has been discovered that the two-flap design described above introduces the risk of entangling animals during passage, leading to injury or death.

Conventional pet doors have addressed the entanglement issue by offering a release mechanism for the second flap. Therefore, upon the occurrence of a pet becoming entangled, the second flap releases itself from the pet door frame and relieves the pet from danger. Conventional release mechanisms include slits that are cut in the weather-resisting flap that cooperate with the pet door frame such that the flap pulls away from the frame upon the application of a force on the flap that is greater than a release force threshold.

These conventional pet doors are limited in that the slits of the weather-resisting flap yield an unpredictable release force threshold. The unpredictability of the release force threshold introduces the possibility that the release mechanism may fail when a pet is in danger or that the weather-resisting flap may be released under standard usage.

### BRIEF SUMMARY OF THE INVENTION

In accordance with the present invention there is provided a pet door for providing ingress or egress, for a pet, through a structural member while offering a weather-resisting feature that prevents the ingress or egress of environmental elements while the pet door is not in use. The pet door includes two flaps that cooperate to bring about the discussed weather-resisting feature offered by the present invention. One of the flaps is a strip covering the gap between the main flap and the frame. The strip is typically U-shaped and introduces a risk of entanglement for a pet when the two flaps assume a particular position. Because the weather-resisting feature includes a flap that introduces the potential to entangle a pet, the pet door provides a snap fastener based release mechanism for releasing the potentially injurious flap upon its entanglement with a pet. The snap fastener provides the potentially entangling flap with release mechanism that has a known release force that is repeatable and can be easily and reliably produced in large-scale manufacturing of the pet door.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an exploded view of a pet door in accordance with the present invention;

FIG. 2a is a perspective view of the pet door of FIG. 1 illustrating the operation of the device during ingress;

FIG. 2b is a perspective view of the pet door of FIG. 1 illustrating the operation of the device during egress; and

FIG. 3 is a perspective view of the pet door of FIG. 1 illustrating the operation of a snap fastener based release mechanism employed by the device.

### DETAILED DESCRIPTION OF THE INVENTION

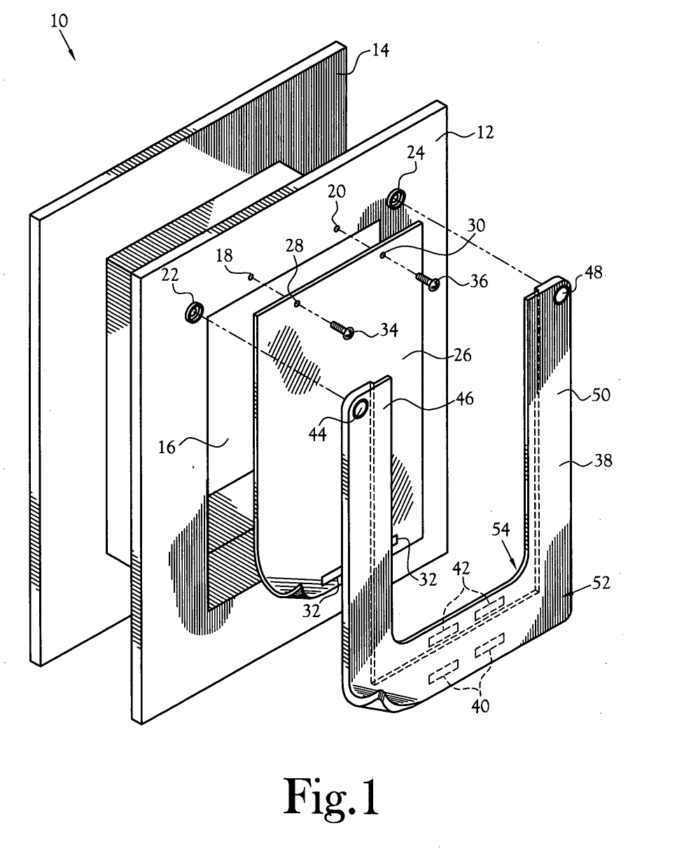

One embodiment of a pet door in accordance with the various features of the present invention is illustrated generally at 10 in FIG. 1. The pet door 10 provides ingress or egress, for a pet, through a structural member, such as a wall, a door, or other element commonly used in construction, while offering resistance against environmental elements while the pet door 10 is not in use. Because the weather-resisting feature includes a strip that introduces the potential to entangle a pet, the pet door 10 provides a snap fastener based release mechanism for releasing the potentially injurious strip should the pet become entangled.

FIG. 1 illustrates an exploded view of the pet door 10. In this particular embodiment, a first frame member 12 cooperates with a second frame member 14 such that when disposed on opposing faces of a structural member that contains a pre-cut opening, the first frame member 12 and the second frame member 14 define a passageway 16 that coincides with the opening. In the illustrated embodiment, the first frame member 12 includes a first female threaded port 18, a second female threaded port 20, a first female snap fastener portion 22, and a second female snap fastener portion 24, each disposed above the passageway 16. Those skilled in the art will recognize that variations in the shape, materials, or construction of the frame or changes in the manner of installation, all of which are well known in the art, would not depart from the scope and spirit of the present invention.

The pet door 10 includes a flap 26 adapted to substantially fill the passageway 16 and to allow movement through the passageway when a force is applied to either face of the flap. The flap 26 may also be referred to as a full flap or a solid flap. Those skilled in the art will recognize that the shape of the flap 26 and the material from which the flap 26 is constructed may vary without departing from the scope and spirit of the present invention. Further, those skilled in the art will recognize that other ways of attaching the flap 26 to the first frame member 12 may be used without departing from the scope and spirit of the present invention.

The pet door 10 further includes an open flap, or strip, 38 that generally follows the perimeter of the passageway 16. The strip 38 overlies and engages both of the flap 26 and the first frame member 12. In the illustrated embodiment, the strip 38 includes a first male snap fastener portion 44 that is disposed at a first terminus 46 of the strip 38 and a second male snap fastener portion 48 that is disposed at a second terminus 50 of the strip 38. The first male snap fastener portion 44 and the second male snap fastener portion 48 cooperate with the first female snap fastener portion 22 and the second female snap fastener portion 24, respectively, such that the strip 38 attaches to the face of the first frame member 12. When attached to the first frame member 12, the strip 38 borders the sides and bottom of the passageway 16 such that an outer portion 52 of the flap engages the first frame member 12 and an inner portion 54 of the flap partially obstructs the passageway 16 and engages the flap 26. The relative positions of the male and female parts of the snap fasteners with respect to the strip and the frame are immaterial so long as a mating relationship is maintained between the strip and the frame.

In one embodiment, the flap 26 is constructed of a flexible material secured to the frame. As illustrated in FIG. 1, the flap 26 includes a first hole 28 and a second hole 30, each disposed at the top of the flap. The flap 26 also includes a first set of magnets 32 that are disposed at the bottom of the flap 26. The flap 26 is secured to the face of the first frame member 12 by a first screw 34 and a second screw 36 that cooperate with the first female threaded port 18 and the second female threaded port 20, respectively. The first screw 34 is inserted into the first hole 28 and then secured to the first female threaded port 18. Likewise, the second screw 36 is inserted into the second hole 30 and then secured to the second female threaded port 20. The flap 26 obstructs the entire passageway 16 when in a resting position. Applying a force to either face of the flap 26 causes the flap 26 to flex and to expose the passageway 16 thereby permitting movement through the passageway 16.

Other materials, movement mechanisms, attachment mechanisms, and arrangements for the flap and the strip are well known to those skilled in the art. For example, substantially rigid materials can be used for the flap and strip with the flap and the strip being hinged or pivotably attached to the frame. Such modifications are considered to be well within the purview of those skilled in the art and do not depart from the scope and spirit of the present invention.

When the pet door 10 is not in use, a releasable coupling provides a temporary bond between the flap 26, the strip 38, and the first frame member 12 to assist in the maintenance of a weather-tight seal. One type of releasable coupling often used in the field of pet doors is a magnetic coupling. The magnetic coupling is maintained between coupling components located in each of the flap 26, the strip 38, and the first frame member 12. These coupling components include some combination of magnets and keepers, which are typically plates of ferromagnetic materials. The coupling components are selected to provide a temporary bond that is selected to be broken when a threshold force is applied to the flap 26, for example, when a pet attempts to pass through the pet door 10.

In the illustrated embodiment, the flap 26 includes a first set of magnets 32 that are disposed at the bottom of the flap 26 and the strip 38 includes a second set of magnets 40 and a third set of magnets 42, which are disposed at the closed-end of the strip 38. The second set of magnets 40 magnetically bonds the strip 38 to the first frame member 12. The third set of magnets 42 magnetically bond with the first set of magnets 32 such that the flap 26 is held in contact with the inner portion 54 of the strip 38. When the aforementioned magnetic bonds are present, the pet door 10 is employing the discussed weather-resisting feature that deters the ingress or egress of environmental elements.

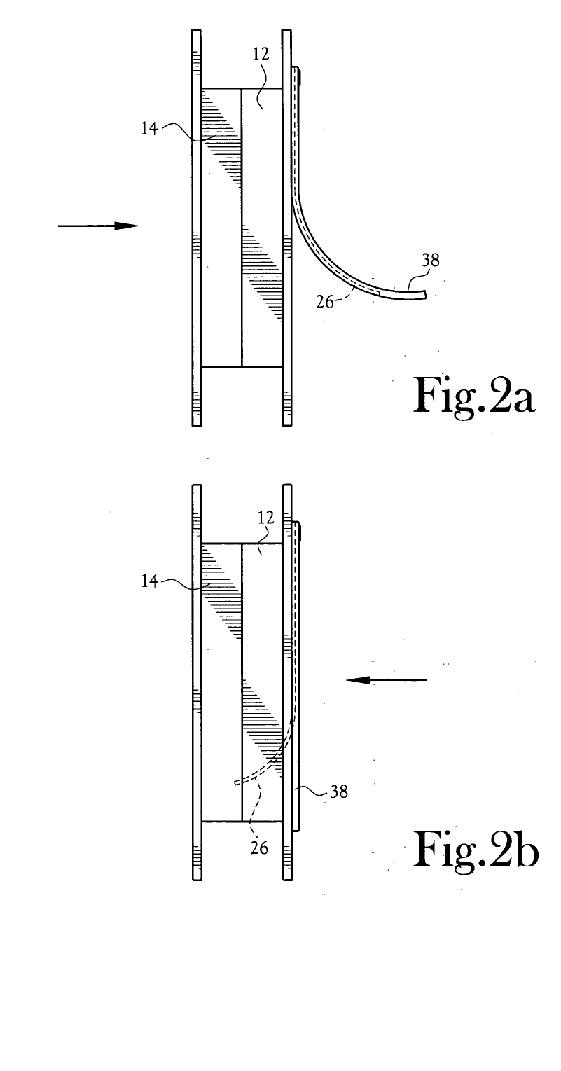

FIG. 2a illustrates the operation of the pet door 10 during the ingression of a pet. Ingression is defined as the passing through the passageway 16 by entering at the second frame member 14 and exiting at the first frame member 12. As a pet applies force to the flap 26 during ingress, the flap 26 applies force to the inner portion 54 of the strip 38, causing the magnetic bond produced by the second set of magnets 40 and the first frame member 12 to be broken. The third set of magnets 42 and the first set of magnets 32 maintain the magnetic bond that secures the flap 26 to the strip 38, causing the flap 26 and the strip 38 to act as one flap that pivots and flexes in the direction of the applied force, allowing the pet passage. When the pet has cleared the passageway 16, the flaps fall to their original position and the second set of magnets 40 reassumes a magnetic bond with the first frame member 12.

FIG. 2b illustrates the operation of the pet door 10 during the egression of a pet. Egression is defined as the passing through the passageway 16 by entering at the first frame member 12 and exiting at the second frame member 14. As a pet applies force to the flap 26 during egress, the magnetic bond produced by the third set of magnets 42 and the first set of magnets 32 is broken because the strip 38, due to its restricting contact with the first frame member 12, is unable to pivot in the direction of the applied force. Therefore, the flap 26 pivots and flexes in the direction of the applied force, allowing the pet passage. When the pet has cleared the passageway 16, the flap 26 falls to its original position and the third set of magnets 42 reassumes a magnetic bond with the first set of magnets 32.

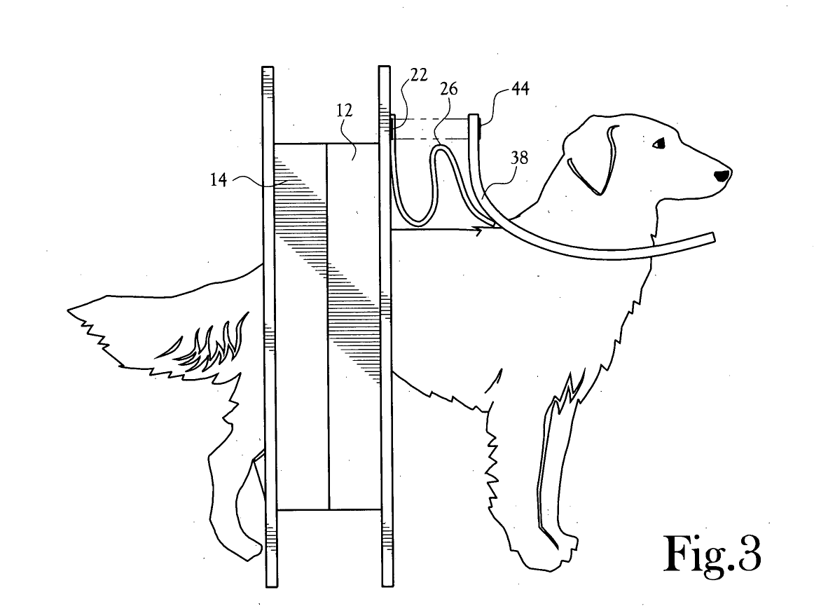

FIG. 3 illustrates the operation of the release mechanism employed by the pet door 10. As discussed, the flap 26 becomes disengaged from the strip 38 due to various forces. When this condition occurs, the risk of a pet becoming entangled with the strip 38 is introduced. When a pet is entangled with the strip 38, it is necessary that the strip 38 be released from the first frame member 12 of the pet door 10 in order to relieve the pet from danger. Because the strip 38 is attached to the first frame member 12 by snap fasteners, the pressure from a struggling pet on the strip 38 unbinds the snap fasteners such that the strip 38 is free from the first frame member 12 and the pet is free from danger.

Because the snap fasteners employed in the present invention are uniformly produced, they offer a consistent release force. This release force is calibrated to accommodate the needs of the pet door 10. As a result, the possibility that the release mechanism may fail when a pet is in danger or that the strip 38 may be released under standard usage is eliminated.

From the foregoing description, those skilled in the art will recognize that a device for providing ingress and egress through a structural member offering advantages over the prior art has been provided. The device provides a weather-resisting feature that prevents the passing of environmental elements through the pet door. The device further provides a release mechanism for reliably releasing a potentially entangling flap. The release mechanism is easily mass produced while still providing a known, uniform, and repeatable release condition.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1: A pet door for allowing a pet access through a structural member, said pet door comprising:
a frame defining a first passageway;
a solid flap attached to said frame, said solid flap sized to substantially fill said passageway and move within said passageway such that the ingress and egress of a pet is allowed, said solid flap having a first face and a second face;
an open flap sized larger than said passageway such that said open flap engages said frame and said solid flap, using at least three sides of said open flap; and
a snap fastener including a first part and a second part adapted to matingly engage and to disengage under due force, said first part carried by said frame, said second part carried by said open flap;
whereby said open flap is moved by said solid flap to allow passage through said first passageway when a force is applied to said first face, and said open flap is restricted from movement by said frame when a force is applied to said second face, revealing a second passageway substantially defined by said open flap.

2: The pet door of claim 1 wherein said solid flap is constructed of a flexible material.

3: The pet door of claim 1 wherein said solid flap is constructed of a rigid material.

4: The pet door of claim 1 wherein said open flap is constructed of a flexible material.

5: The pet door of claim 1 wherein said open flap is constructed of a rigid material.

6: The pet door of claim 1 wherein said open flap is substantially U-shaped.

7: The pet door of claim 1 wherein said open flap is substantially O-shaped.

8: The pet door of claim 1 wherein said solid flap and said open flap cooperate to produce a weather-resisting feature that prevents the passing of environmental elements through said first passageway.

9: The pet door of claim 8 wherein said solid flap includes a first magnetic coupling and said open flap includes a second magnetic coupling, whereby said first magnetic coupling and said second magnetic coupling hold said solid flap and said open flap in contact until a force from a pet separates said solid flap and said open flap.

10: The pet door of claim 9 wherein said frame includes a third magnetic coupling such that said third magnetic coupling and said first magnetic coupling hold said frame and said solid flap in contact until a force from a pet separates said frame and said solid flap.

11: The pet door of claim 9 wherein said frame includes a fourth magnetic coupling such that said fourth magnetic coupling and said second magnetic coupling hold said frame and said open flap in contact until a force from a pet separates said frame and said open flap.

12: The pet door of claim 1 wherein said snap fasteners are calibrated to release from said passageway frame at a particular release force threshold.

13: A pet door for allowing a pet access through a structural member, said pet door comprising:
a means for framing an opening in a structural member such that a passageway is defined;
a means for obstructing said passageway, means for obstructing said passageway allowing the ingress and egress of a pet; and
a means for releasing said means for obstructing said passageway.

14: The pet door of claim 13 further comprising a means for sealing, said means for sealing providing a weather-resisting feature that prevents the passage of environmental elements through said passageway.

15: A pet door for allowing a pet access through a structural member, said pet door comprising:
a frame member for framing an opening within a structural member, said frame member defining a passageway through said structural member;
a first flap attached to said frame member such that said first flap obstructs said passageway while maintaining the ability to pivot through said passageway; and
a second flap attached to said frame member such that said second flap contacts said frame member and said first flap for producing a weather-resisting feature, said second flap constructed such that a pet is able pass though an open portion of said second flap, said second flap attached to said frame member by way of snap fasteners such that a force greater than a release force threshold applied to said second flap unbinds said snap fasteners and releases said second flap from said frame member.

16: The pet door of claim 15 wherein said first flap is constructed of a flexible material.

17: The pet door of claim 15 wherein said second flap is constructed of a flexible material.

18: The pet door of claim 15 where said first flap is constructed of a rigid material.

19: The pet door of claim 15 wherein said second flap is substantially U-shaped.

20: The pet door of claim 15 wherein said second flap is substantially O-shaped.

21: A pet door comprising:
a frame defining a passageway;
a flap connected to said frame and residing within said passageway, said flap adapted to move within said passageway when a force is applied to said flap, said flap having a first face and a second opposing face;
a strip following a substantial portion of a periphery of said passageway; said strip overlapping and engaging both said frame and said flap;
a snap fastener including a first part and a second part, said first part and said second part adapted to releasably matingly engage, said first part attached to said frame, said second part attached to said strip.

22: The pet door of claim 21 wherein said snap fastener has a preselected release force under which said first part and said second part disengage.

23: The pet door of claim 21 further comprising a releasable coupling between said strip and said frame, said releasable coupling temporarily holding said strip in engagement with said frame to effect a substantially weather-tight seal when said pet door is not in use.

24: The pet door of claim 21 further comprising a releasable coupling including a first part attached to said strip and a second part attached to said frame, wherein said strip remains in engagement with said frame and becomes disengaged from said flap when a force is applied to said flap first face such that said flap moves to allow passage through said passageway and said strip disengages from said frame and remains in engagement with and moves with said flap when a force is applied to said flap second face such that said flap moves to allow passage through said passageway.

25: The pet door of claim 21 wherein said strip has a first terminal end and a second terminal end, said strip including a snap fastener second part disposed proximate to each of said first terminal end and said second terminal end, said frame having a corresponding said snap fastener first part.
